(19) United States
(12) Patent Application Publication
(10) Pub. No.: US 2014/0303798 A1
(43) Pub. Date: Oct. 9, 2014

(54) SYSTEMS AND METHODS FOR OPTIMIZED OPERATION OF AN INDUSTRIAL PRODUCTION OR MANUFACTURING FACILITY

(71) Applicant: ABB TECHNOLOGY AG, Zurich (CH)

(72) Inventors: Sleman SALIBA, Heidelberg (DE); liro HARJUNKOSKI, Weinheim (DE); Manfred RODE, Wiesloch (DE); Guido SAND, Weinheim (DE); Jan Christoph SCHLAKE, Darmstadt (DE)

(73) Assignee: ABB TECHNOLOGY AG, Zurich (CH)

(21) Appl. No.: 14/308,358

(22) Filed: Jun. 18, 2014

Related U.S. Application Data
(63) Continuation of application No. PCT/EP2011/073211, filed on Dec. 19, 2011.

(51) Int. Cl. G06Q 50/06

(52) U.S. Cl. CPC G06Q 50/06
USPC 700/291

(57) ABSTRACT

A production planning system and a system for energy supply planning are configured to determine a production schedule and an energy supply schedule, respectively, by interactively and mutually exchanging scheduling information with the respective other system and by taking the received scheduling information into account during the planning of the respective schedule. The interacting is performed in a kind of handshaking during planning of the respective schedules, where each of the two systems waits with the next iteration step until the other system delivers its updated schedule.

### RELATED APPLICATION

This application claims priority as a continuation application under 35 U.S.C. §120 to PCT/EP2011/073211 filed as an International Application on Dec. 19, 2011 designating the U.S., the entire content of which is hereby incorporated by reference in its entirety.

### FIELD

The present disclosure relates to a production planning system for optimized operation of an industrial production or manufacturing facility, which includes a production scheduling unit configured to determine an initial production schedule for the industrial production or manufacturing facility, and to a system for energy supply planning of an energy supplying facility including an energy supply scheduling unit. The present disclosure also relates to corresponding methods performed by the production planning system and the system for energy supply planning.

### BACKGROUND INFORMATION

In industrial manufacturing or production facilities, the optimized operation of the production is ensured by applying so-called production management systems. The term “industrial manufacturing facility” hereby refers to those enterprises which generate their products by discrete manufacturing, where the products are, for example, toys, cars, tools, medical equipment, computers or mobile phones. The term “industrial production facility” is used for enterprises which belong to the process industry applying continuous production processes to produce, for example, metals, paper, plastics, chemicals, pharmaceuticals, food and beverages. In the following, the terms manufacturing and production are used as synonyms.

Production management systems, also known as manufacturing intelligence systems, often provide the operator of a production plant with the possibility to optimize the operation of the plant with respect to different optimization goals, such as resource efficiency, reaction times and product quality. Known production management systems with optimization functionality are, for example, ABB's Collaborative Production Management (CPM) solutions.

In the future, the specific optimization goal of resource efficiency will gain more and more importance, in particular with respect to energy efficiency. Accordingly, the aspect of optimizing manufacturing processes with respect to a minimized energy demand or an optimal use of available energy resources are coming more and more into focus.

In WO 03/056480 A2, a system for dynamic, model-based planning and optimization of production processes is disclosed. There, in a first step, a first production plan is automatically generated based on information about available resources, including raw materials and energy resources. This first production plan is optimized in a second step with respect to the production goal. In case of unexpected changes in the available resources, the optimized production plan may then be adapted to these changes.

In other words, the production planning system of WO 03/056480 A2 uses information about expected available energy resources at the one time when the first production plan, which is an un-optimized, long-term production plan, is generated. After a subsequent optimization of the long-term plan with respect to the production goal, the production planning system only reacts to status information and accordingly adapts a short-term production plan in case that unexpected changes occur. Such short-term re-planning is usually sub-optimal since the little time available for reaction to the unexpected changes does not allow for all the adaptations necessary for an optimal response. As a result, productivity decreases.

The problem of adapting a production plan to the availability of energy resources is also dealt with in PCT/EP2011/004954. There, the point of an increased use of renewable energy resources is raised, which results in the currently observable spread of so called smart grids connected with an increasing time-dependent variability of the amount of available energy. In PCT/EP2011/004954, a production planning system optimizes a production plan with respect to two goals: the availability of energy and the energy consumption. This is done in a coordinated manner. The two optimization results are afterwards assessed with respect to an overall optimization goal.

On the side of energy suppliers, the problem of variation in the available energy amount is dealt with in different ways. One solution for those time periods when an energy shortage is observed is for example to inform the customer about an electricity consumption threshold and to enforce this threshold by interrupting the supply of electricity to the consumer if the threshold was not adhered to during a given time period, as is described in WO 2009/063397 A2. In the case of a production or manufacturing facility on the consumer side, this approach results in an unwanted reduction or even stop of the production during energy shortage times, leading to a reduction of the throughput and the productivity of the facility.

Another solution is the use of consumption forecasts delivered by the energy consumers so that the energy supplier may plan ahead the production of the requested energy in adaptation to these forecasts, where the energy production is changed by switching on or off an appropriate number of power plants. This is for example described in “Networking” by Jaakko Junttila and Marja-Liisa Parkkinen, ABB Review 3/2005. In the article, the mentioned energy supplier is at the same time operator of production sites for printing paper. An energy consumption forecast is derived from a production grade and rate as planned by a production planning system. In the next step, energy resources are selected to match the time-varying energy consumption, and in case that the available internal energy amount is insufficient, energy is purchased from outside suppliers. On the other hand, any energy surplus is sold to external partners.

### SUMMARY

An exemplary embodiment of the present disclosure provides a production planning system for optimized operation of an industrial production or manufacturing facility. The exemplary system includes a production scheduling unit configured to determine an initial production schedule for the industrial production or manufacturing facility, an internal communication interface unit configured to be connected to a control system of the industrial production or manufacturing facility, and an external communication interface unit configured to be connected to a system for energy supply planning. The external communication interface unit is configured to transmit at least one of the initial production schedule and initial energy demand data derived from the initial production schedule to the system for energy supply planning. The external communication interface unit is configured to receive, from the system for energy supply planning, an initial energy supply schedule containing information which reflects at least one of a time-dependent abundance and a time-dependent abundance shortage of energy available to the industrial production or manufacturing facility via at least one energy supply line. The production scheduling unit is configured to determine an adapted production schedule based on at least the initial production schedule and the initial energy supply schedule by re-scheduling at least one production process so that the energy demand of the at least one production process is reduced during a time period when available energy is in short or average supply. The external communication interface unit is configured to transmit at least one of the adapted production schedule and adapted energy demand data derived from the adapted production schedule to the system for energy supply planning. The internal communication interface unit is configured to transmit the adapted production schedule to the control system for controlling the operation of the industrial production or manufacturing facility according to the adapted production schedule.

An exemplary embodiment of the present disclosure provides a system for energy supply planning of an energy supplying facility. The exemplary system includes an energy supply scheduling unit, an internal communication interface unit configured to be connected to a control system of the energy supplying facility, an external communication interface unit configured to be connected to a production planning system for optimized operation of an industrial production or manufacturing facility. The external communication interface unit is configured to receive at least one of an initial production schedule and initial energy demand data from the production planning system. The energy supply scheduling unit is configured to determine, based on at least one of the initial production schedule and the initial energy demand data, an initial energy supply schedule reflecting an expected time-dependent infeed of energy into at least one energy supply line, the industrial production or manufacturing facility being connected to the at least one energy supply line. The external communication interface unit is configured to transmit the initial energy supply schedule to the production planning system and to receive, from the production planning system, at least one of an adapted production schedule and adapted energy demand data. The energy supply scheduling unit is configured to determine an adapted energy supply schedule based on the initial energy supply schedule and at least one of the adapted production schedule and the adapted energy demand data. The internal communication interface unit is configured to transmit the adapted energy supply schedule to the control system for controlling the operation of the energy supplying facility according to the adapted energy supply schedule.

An exemplary embodiment of the present disclosure provides a method for optimized operation of an industrial production or manufacturing facility, wherein an initial, production schedule for the industrial production or manufacturing facility is determined. The exemplary method includes establishing a communication connection to a system for energy supply planning, and transmitting at least one of the initial production schedule and initial energy demand data derived from the initial production schedule to the system for energy supply planning. The exemplary method also includes receiving, from the system for energy supply planning, an initial energy supply schedule containing information which reflect at least one of a time-dependent abundance of energy and a time-dependent shortage of energy available to the industrial production or manufacturing facility via at least one energy supply line. In addition, the exemplary method includes determining an adapted production schedule based on the initial production schedule and the initial energy supply schedule by re-scheduling at least one production process so that the energy demand of the at least one production process is reduced during a time period when available energy is in short supply an increased during a time period when available energy is not in short supply. Furthermore, the exemplary method includes transmitting at least one of the adapted production schedule and adapted energy demand data derived from the adapted production schedule to the system for energy supply planning, and transmitting the adapted production schedule to the control system for controlling the operation of the industrial production or manufacturing facility according to the adapted production schedule.

An exemplary embodiment of the present disclosure provides a method for energy supply planning of an energy supplying facility. The exemplary method includes receiving at least one of an initial production schedule and initial energy demand data from a production planning system for optimized operation of an industrial production or manufacturing facility, and determining, based on at least one of the initial production schedule and the initial energy demand data, an initial energy supply schedule reflecting an expected time-dependent infeed of energy into at least one energy supply line, the industrial production or manufacturing facility being connected to the at least one energy supply line. In addition, the exemplary method includes transmitting the initial energy supply schedule to the production planning system and receiving, from the production planning system, at least one of an adapted production schedule and adapted energy demand data. The exemplary method also includes determining an adapted energy supply schedule based on the initial energy supply schedule and at least one of the adapted production schedule and the adapted energy demand data, and transmitting the adapted energy supply schedule to the control system for controlling the operation of the energy supplying facility according to the adapted energy supply schedule.

### BRIEF DESCRIPTION OF DRAWINGS

Additional refinements, advantages and features of the present disclosure are described in more detail below with reference to exemplary embodiments illustrated in the drawings, in which:

FIG. 1 is a block diagram of a production planning system and a system for energy supply planning interacting with each other, according to an exemplary embodiment of the present disclosure;

FIG. 2 is a flow diagram of a method performed by the production planning system, according to an exemplary embodiment of the present disclosure; and

FIG. 3 is a flow diagram of a method performed by the system for energy supply planning, according to an exemplary embodiment of the present disclosure.

### DETAILED DESCRIPTION

Exemplary embodiments of the present disclosure improve the known systems and methods for management and optimization of the operation of an industrial production or manufacturing facility with respect to the availability of energy resources.

Exemplary embodiments of the present disclosure provide a production planning system for optimized operation of an industrial production or manufacturing facility and a system for energy supply planning of an energy supplying facility, as well as corresponding methods as described herein.

A main feature of the production planning system and of the system for energy supply planning according to the present disclosure is that both are configured to determine a production schedule and an energy supply schedule, respectively, by interactively and mutually exchanging scheduling information with the respective other system and by taking the received scheduling information into account during the planning of the respective schedule.

The present disclosure also covers corresponding methods performed by the production planning system and the system for energy supply planning.

The term “production schedule” is used here for a time-dependent plan or timetable which defines as a minimum when what kind and what amount of resources, staff and equipment is to be used in the operation of the industrial production or manufacturing facility. In addition, it could be further specified for example in what way the resources, staff and equipment are to be used.

The term “energy supply schedule” is used for a time-dependent plan or timetable which defines as a minimum when what kind and what amount of energy is available to the industrial production or manufacturing facility. It may further define the type of energy or type of source the energy comes from as well as under which conditions the amount of energy is available, for example for what price.

Both types of schedules cover a time period in the future, which lies ahead either in a mid-term range of between a few days up to a couple of weeks, maximum 6 weeks, or in a long term range of between one to a few months, maximum 6 months.

The term “energy” is mainly used for electricity, but also covers additional types of energy delivered to a production site via supply lines and ready to be used directly, without any transformation into another energy form, such as steam or heated water.

According to an exemplary embodiment of the present disclosure, the production planning system includes an external communication interface unit which is configured to be connected to the system for energy supply planning. The external communication interface unit is configured to transmit an initial production schedule and/or initial energy demand data derived from the initial production schedule to the system for energy supply planning and to receive from the system for energy supply planning an initial energy supply schedule containing information which reflect a time-dependent abundance and/or shortage of energy available to the industrial production or manufacturing facility via at least one energy supply line. A production scheduling unit, which belongs to the production planning system, is configured to determine an adapted production schedule based on at least the initial production schedule and the initial energy supply schedule by re-scheduling at least one production process so that the energy demand of the at least one production process is at least reduced during a time period when available energy is in short or average supply. Further, the external communication interface unit is configured to transmit the adapted production schedule and/or adapted energy demand data derived from the adapted production schedule to the system for energy supply planning; and an internal interface unit is configured to transmit the adapted production schedule to a control system for controlling the operation of the industrial production or manufacturing facility according to the adapted production schedule.

The system for energy supply planning, on the other side of the scheduling interaction, includes an external communication interface unit which is configured to be connected to the production planning system. The external communication interface unit is configured to receive the initial production schedule and/or initial energy demand data from the production planning system. An energy supply scheduling unit belonging to the system for energy supply planning is configured to determine, based on at least the initial production schedule and/or the initial energy demand data, an initial energy supply schedule reflecting an expected time-dependent infeed of energy into at least one energy supply line, where the industrial production or manufacturing facility is connected to the at least one energy supply line. The external communication interface unit is configured to transmit the initial energy supply schedule to the production planning system and to receive from the production planning system an adapted production schedule and/or adapted energy demand data. The energy supply scheduling unit is further configured to determine an adapted energy supply schedule based on at least the initial energy supply schedule and the adapted production schedule and/or the adapted energy demand data; and an internal communication interface unit is configured to transmit the adapted energy supply schedule to a control system for controlling the operation of the energy supplying facility according to the adapted energy supply schedule.

The systems according to the present disclosure generate their respective mid- or long-term schedule through an interaction with each other, for example, the production schedule is not regarded to be ready before it is not adjusted to the energy supply schedule which itself is not sent out before it is not adjusted to at least an initial production schedule and which is not regarded to be ready before it is not adjusted to the adjusted production schedule. In other words, the production plant not simply tells the energy supplier how much energy the plant will need because of the production plan, nor the energy supplier simply tells the production plant how much energy it will get, but instead both players interact to generate the best production plan with the best energy mix provided by the energy supplier.

In this way, the timetables of energy demand and energy supply are matched in an optimized way, thereby ensuring operation of the industrial production or manufacturing facility at an optimized productivity level while minimizing the necessity for the installation of additional energy back-up or energy storage devices. Further, the energy distribution grid is stabilized due to the optimally adjusted energy demand and the operation of the energy supplying facility is simplified since the number of interventions with respect to switching on or switching off of back-up power plants is reduced.

In accordance with an exemplary embodiment of the production planning system, the production scheduling unit is configured to re-schedule the at least one production process so that the energy demand of the at least one production process is only increased during a time period when available energy is not in short supply. For example, this time period when the energy demand is increased is a time period when available energy is in abundant supply.

The term re-scheduling is used to describe that the time-tables created during planning of the at least one production process are changed so that the energy demand of the production process is adapted to the availability of the energy as closely as possible. In its simplest form a re-scheduling could be achieved by shifting the whole production process from a time period with low to a time period with high availability of energy, or in other words, by just re-arranging the one time-table of the overall production process. According to an exemplary embodiment, the re-scheduling is a much more advanced function which re-plans individual and multiple time-tables belonging to the use, mode of operation and interoperation of parts of the production equipment and of sub-processes. The first aim of the re-scheduling is to decrease the energy demand during time periods when little or an average amount of energy is available. In the best case, this aim is achieved without needing to increase the energy demand during other time periods. If this is not possible, it is the second aim of the re-scheduling to increase the energy demand only during time periods when available energy is not in short supply, for example, a decrease during one low-energy or average-energy time period shall not be compensated by an increase during another low-energy time. Instead, an increase is allowed only during times when the availability of energy is at least on average level.

From the perspective of the energy supplying facility, it would be advantageous that the increase of the energy demand is planned for a high-energy time, also called a time period when available energy is in abundant supply. However, in certain situations, for example, when these time periods lie a considerable time period apart or when deadlines have to be met, it may be advantageous for the production or manufacturing facility to shift the energy demand of the at least one production process only to a time period with normal or average availability of energy. This is acceptable as well, since the energy supplying facility would then, in the next iteration step, gets the chance to adapt its energy supply schedule accordingly.

Advantageously, energy-intensive production processes are re-scheduled first since their impact on a change in the energy demand is highest.

In accordance with an exemplary embodiment of the production planning system, the external communication interface is configured to receive from the system for energy supply planning an adapted energy supply schedule, the production scheduling unit is configured to determine a further adapted production schedule based on at least the adapted energy supply schedule and the adapted production schedule, the external communication interface unit is configured to transmit the further adapted production schedule and/or further adapted energy demand data derived from the further adapted production schedule to the system for energy supply planning, and the internal interface unit is configured to transmit the further adapted production schedule to the control system for controlling the operation of the industrial production or manufacturing facility according to the further adapted production schedule.

This means that the interaction between the production planning system and the system for energy supply planning is not limited to just one iteration on both sides but to more iterations, if regarded to be necessary or until an optimum is reached. For example, it could be defined that the iterations are proceeded with until on both sides the next iteration step does not yield a further improvement in the resulting schedule or until the weather forecast is regarded to be sufficiently reliable.

The further adapted production schedule may be determined taking into account not only the results of the previous iteration but also of iterations lying further in the past, such as the initial production schedule and the initial energy supply schedule.

With respect to the system for energy planning, the embodiment for further iterations includes the features that the external communication interface is configured to transmit the adapted energy supply schedule to the production planning system and to receive from the production planning system a further adapted production schedule and/or further adapted energy demand data, the energy supply scheduling unit is configured to determine a further adapted energy supply schedule based on at least the adapted energy supply schedule and the further adapted production schedule and/or energy demand data, and the internal communication interface unit is configured to transmit the further adapted energy supply schedule to the control system for controlling the operation of the energy supplying facility according to the further adapted energy supply schedule.

In accordance with an exemplary embodiment of the production planning system, the production scheduling unit is configured to determine the initial production schedule based on at least a schedule of a required output of the production, where the term “required output” means the amount of a certain product or certain products required to be finished at a specified point in time in the future.

On the other side of the interaction cycle, the energy supply scheduling unit may be configured to determine the initial energy supply schedule by further taking into account a forecast for an availability of energy sources, for example, a weather forecast. A weather forecast is useful in order to predict the availability of renewable energy sources, such as wind, sun or water. Other possible forecasts for an availability of energy sources can for example be a delivery plan for fossil energy carriers, like coal, oil and gas, to be delivered to a power plant belonging to the energy supplying facility.

In accordance with an exemplary embodiment of the production planning system, the external communication interface is configured to receive information about a status of the energy supplying facility and/or an unexpected change in the initial or adapted energy supply schedule, the production scheduling unit is configured to determine an ad-hoc production schedule based on at least the adapted or further adapted production schedule and by taking into account the status and/or unexpected change, and the internal interface unit is configured to transmit the ad-hoc production schedule to the control system for controlling the operation of the industrial production or manufacturing facility according to the ad-hoc production schedule.

This embodiment takes into account unplanned changes in the energy supply, for example due to power outages or malfunctions, and adapts the production schedule accordingly. The ad-hoc production schedule is a short-term production schedule with a time horizon of only a few hours up to a few days in the future, e.g., with respect to time it stands in contrast to the regular mid-term or long-term production schedule.

In accordance with an exemplary embodiment of the production planning system, the production scheduling unit is configured to determine the initial, adapted and/or further adapted production schedule by further taking into account at least one of a pre-defined capacity utilization, energy efficiency, output quality and throughput time of the industrial production or manufacturing facility.

An exemplary embodiment of the energy supplying facility encompasses the control system being configured to control the operation of the energy supplying facility such that at least one power generation unit is switched on or off and/or a specific energy amount is directed towards the at least one energy supply line or away from it. The at least one power generation unit may be a so-called back-up power plant, which is usually a plant with a moderate ramp-up and/or shut-down time, such as a coal power plant. In a wider sense, it may also be a unit which couples energy from an energy storage device into the energy supply network.

In case that the production planning system only transmits the production schedule to the energy supplying facility, the energy supply scheduling unit is configured to derive initial, adapted and/or further adapted energy demand data from the initial, adapted and/or further adapted production schedule, respectively. In that case, the energy supply scheduling unit is provided with further pre-defined information relating to the production or manufacturing facility, for example about the energy use or energy efficiency of the production equipment.

In accordance with an exemplary embodiment of the energy supplying facility, the energy supply scheduling unit is configured to determine the initial, adapted and/or further adapted energy supply schedule by further taking into account at least one of a pre-defined mixture of different energy sources, amount of stored energy, available energy storage capacity, ramp-up and shut-down time of at least one power generation unit.

In general, the present disclosure is particularly advantageous for industrial production or manufacturing facilities belonging to an energy intensive industry sector, in particular to metals processing. In metals processing, the energy demand can be varied noticeably by changing the operation times and/or modes of the furnaces, such as electric arc furnaces or basic oxygen furnaces. For such furnaces, the most energy-intensive operation modes are the ramp-up and ramp-down. This is the reason for a commonly applied restriction, namely to operate the multiple of furnaces used in one metals production facility in a time-shifted manner, with only some of the furnaces being operated simultaneously. Due to the present disclosure, it becomes possible to lift this restriction and to couple the number of simultaneously operated furnaces directly to the amount of available energy.

Apart from that it is possible that the energy supplying facility belongs either to the same enterprise as the industrial production or manufacturing facility or to an independent energy supply company. Especially production plants from the energy intensive industry sectors often have their own power generation plants in order to cover the considerable and unevenly occurring considerable energy demand. These plants may be situated in geographic proximity to each other and are usually operated by the same company so that the implementation of the interaction according to the present disclosure would be especially feasible.

In case of a power plant belonging to the production plant, the at least one energy supply line may be a direct line between the energy supplying facility and the industrial production or manufacturing facility. Otherwise, it may also belong to an energy distribution network.

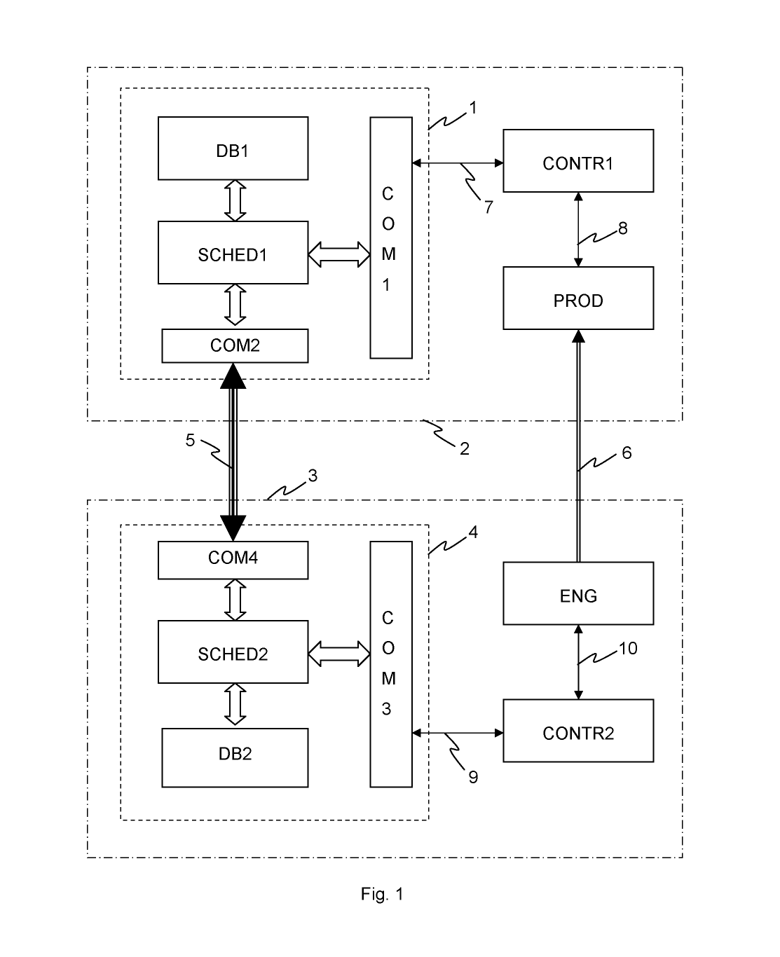

FIG. 1 shows an industrial production facility 2 including a production planning system 1, a control system CONTR1 and production equipment PROD, the operation of which is controlled by the control system CONTR1. The industrial production facility 2 is, for example, a metals processing plant, and the production equipment PROD includes, among others, three energy-intensive electric arc furnaces. The production planning system 1 contains a production scheduling unit SCHED1, an internal communication interface COM1, an external communication interface COM2 and a data storage unit DB1. All elements contained in the production scheduling unit SCHED1 exchange data via internal communication lines indicated by block arrows. These data can be transmitted by the internal communication interface COM1 to the control system CONTR1 via data communication line 7. The control system CONTR1 sends actuating information to and receives measurement and/or status information from the production equipment PROD via communication line 8.

In FIG. 1, it is further seen an energy supplying facility 3 including a system 4 for energy supply planning, a control system CONTR2 and energy generation and supplying equipment ENG, the operation of which is controlled by the control system CONTR2. The system 4 for energy supply planning contains an energy supply scheduling unit SCHED2, an internal communication interface COM3, an external communication interface COM4 and a data storage unit DB2. All elements contained in the energy supply scheduling unit SCHED2 exchange data via internal communication lines indicated by block arrows. These data can be transmitted by the internal communication interface COM3 to the control system CONTR2 via data communication line 9. The control system CONTR2 sends actuating information to and receives measurement and/or status information from the energy generation and supplying equipment ENG via communication line 10. The energy generation and supplying equipment ENG delivers energy to the production equipment PROD via an energy supply line 6, which may belong to an energy distribution network. As used herein, the term “unit” connotes a component of the above-described systems. The units may be implemented by one or more computer processors of one or more computer processing devices (e.g., desktop, laptop and/or portable computers such as tablet computers) executing a computer-readable program tangibly recorded on a non-transitory computer-readable recording medium that, when executed, causes the computer processors to carry out the operative functions of the units as described herein.

According to an exemplary embodiment of the present disclosure, a communication link 5 exists between the production planning system 1 and the system 4 for energy supply planning for exchanging of production and energy supply schedules, respectively. The communication link 5 can for example be a wireless or wire-bound data communication line or network, or it can be established via a commonly accessible database.

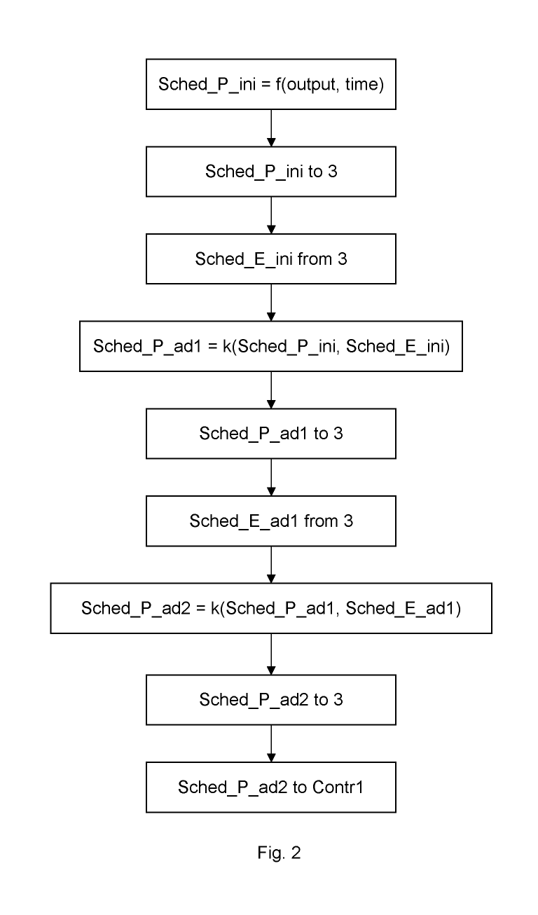

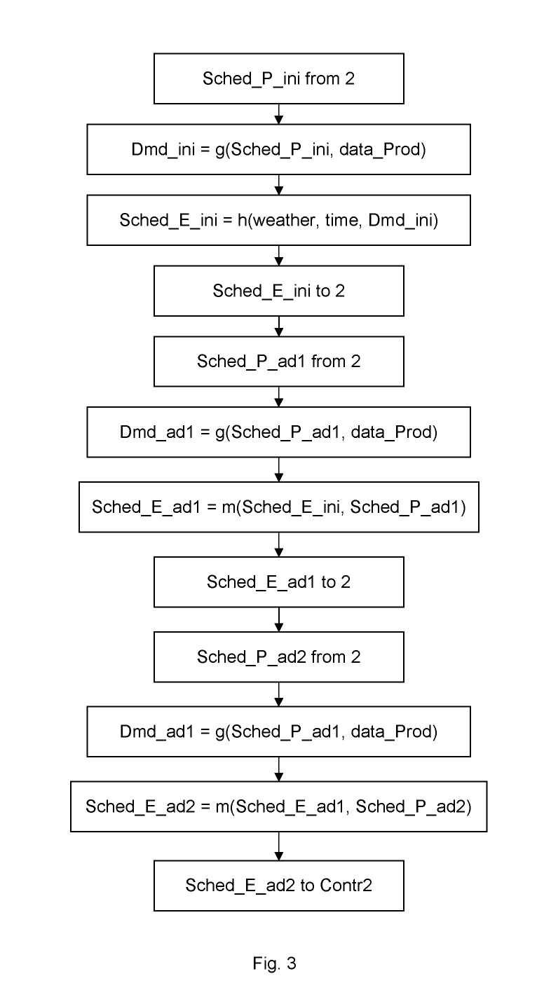

Examples for the interaction between the production planning system 1 and the system 4 for energy supply planning are now explained with respect to the methods shown in FIGS. 2 and 3.

In FIG. 2, a method is shown which is performed by the production planning system 1 and in FIG. 3 a method is shown which is performed by the system 4 for energy supply planning concurrently with the method of FIG. 2.

First, an initial production schedule Sched_P_ini is determined by production scheduling unit SCHED1 as a function f which depends at least on a requested time-dependent output of the production, where the production is planned for a time period which lies two weeks ahead. Then, the external communication interface unit COM2 transmits the initial production schedule Sched_P_ini via communication link 5 to the system 4 for energy supply planning, and there in particular to the external communication interface unit COM4 where it is received (first step of FIG. 3). From the initial production schedule Sched_P_ini and further information data_Prod about the energy use of the production equipment PROD, the energy supply scheduling unit SCHED2 then derives initial energy demand data Dmd_ini as the time-dependent result of function g.

In the next step, the energy supply scheduling unit SCHED2 determines from time-dependent information about what the weather will be like in the future, e.g., weather forecast information, and from the initial energy demand data Dmd_ini an initial energy supply schedule Sched_E_ini via an optimization function h, where the optimization function h takes into account the possible usage of energy storage devices in order to match the time periods of a high energy demand to the time periods when sufficiently enough energy can be supplied, even if the weather forecast promises the availability of renewable energy sources, such as wind or sun, during different time-periods. This initial energy supply schedule Sched_E_ini is then sent by external communication interface unit COM4 via communication link 5 to the external communication interface unit COM2 of the product planning system, where it is received.

Afterwards, the production scheduling unit SCHED1 adapts the initial production Sched_P_ini to the time-dependent energy availability information contained in the energy supply schedule Sched_E_ini by using an optimization function k, where the optimization function k re-schedules energy-intensive production processes, in this example the use of the electric arc furnaces so that the energy demand decreases during time periods when the energy is in short supply and increases during time-periods when the energy is in abundant supply, as long as the productivity of the metals processing plant is not negatively affected. Otherwise, the shifting is performed only towards time periods when the energy is in average supply. The output of optimization function k is an adapted production schedule Sched_P_ad1, which is sent to the external communication interface COM4.

From the adapted production schedule Sched_P_ad1, the energy supply scheduling unit SCHED2 derives again the corresponding energy demand data using the above described function g. The result, which is the adapted energy demand data, is then—together with the initial energy supply schedule Sched_E_ini—input to an optimization function m which again tries to match the energy demand to the energy supply by trying to keep the productivity of the energy supplying facility at a highest possible level. The output of the optimization function m is the adapted energy supply schedule Sched_E_ad1, which is sent back to the production scheduling unit SCHED1 via external communication interfaces COM4 and COM2.

The production scheduling unit SCHED1 takes again the production schedule and the energy supply schedule, this time in their adapted versions Sched_P_ad1 and Sched_E_ad1, and applies optimization function k in order to further optimize the production schedule. The result is the further adapted production schedule Sched_P_ad2.

The number of iterations is limited in this example to two. Therefore, the further adapted production schedule Sched_P_ad2 is regarded to be the final one, so that it is not only sent out to the energy supply scheduling unit SCHED2 but also, by the internal communication interface COM1 via data communication line 7, to the control system CONT1 which uses it to control the operation of the production equipment PROD and in particular the operation of the electric arc furnace, accordingly.

In the energy supply scheduling unit SCHED2, the same steps are performed with the further adapted production schedule Sched_P_ad2 as before with the adapted production schedule Sched_P_ad1, e.g., further adapted energy demand data Dmd_ad2 are derived using function g and a further adapted energy supply schedule Sched_E_ad2 is determined by applying optimization function h. The further adapted energy supply schedule Sched_E_ad2 is then transmitted by the internal communication interface COM2 via data communication line 9 to the control system 9, where it is used as the base for controlling the operation of energy generation and supplying equipment ENG in order to supply the amount of energy as planned at the promised point in times via energy supply line 6 to the production equipment PROD.

As can be understood from FIGS. 2 and 3, the production planning system 1 and the system 4 for energy supply planning interact by performing a kind of handshaking during planning of their respective schedules, where each of the two systems waits with the next iteration step until the other system delivers its updated schedule.

It will therefore be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A production planning system for optimized operation of an industrial production or manufacturing facility, the system comprising:
a production scheduling unit configured to determine an initial production schedule for the industrial production or manufacturing facility;
an internal communication interface unit configured to be connected to a control system of the industrial production or manufacturing facility; and
an external communication interface unit configured to be connected to a system for energy supply planning, wherein:
the external communication interface unit is configured to transmit at least one of the initial production schedule and initial energy demand data derived from the initial production schedule to the system for energy supply planning;
the external communication interface unit is configured to receive, from the system for energy supply planning, an initial energy supply schedule containing information which reflects at least one of a time-dependent abundance and a time-dependent abundance shortage of energy available to the industrial production or manufacturing facility via at least one energy supply line;
the production scheduling unit is configured to determine an adapted production schedule based on at least the initial production schedule and the initial energy supply schedule by re-scheduling at least one production process so that the energy demand of the at least one production process is reduced during a time period when available energy is in short or average supply;
the external communication interface unit is configured to transmit at least one of the adapted production schedule and adapted energy demand data derived from the adapted production schedule to the system for energy supply planning; and
the internal communication interface unit is configured to transmit the adapted production schedule to the control system for controlling the operation of the industrial production or manufacturing facility according to the adapted production schedule.

2. The system according to claim 1, wherein the production scheduling unit is configured to re-schedule the at least one production process so that the energy demand of the at least one production process is increased during a time period when available energy is not in short supply.

3. The system according to claim 1, wherein
the external communication interface is configured to receive, from the system for energy supply planning, an adapted energy supply schedule;
the production scheduling unit is configured to determine a further adapted production schedule based on the adapted energy supply schedule and the adapted production schedule;
the external communication interface unit is configured to transmit at least one of the further adapted production schedule and further adapted energy demand data derived from the further adapted production schedule to the system for energy supply planning; and
the internal communication interface unit is configured to transmit the further adapted production schedule to the control system for controlling the operation of the industrial production or manufacturing facility according to the further adapted production schedule.

4. The system according to claim 1, wherein the production scheduling unit is configured to determine the initial production schedule based on a schedule of a required output of the production.

5. The system according to claim 3, wherein:
the external communication interface is configured to receive information about at least one of a status of the energy supplying facility and an unexpected change in the initial or adapted energy supply schedule;
the production scheduling unit is configured to determine an ad-hoc production schedule based on the adapted or further adapted production schedule and by taking into account at least one of the status and unexpected change; and
the internal communication interface unit is configured to transmit the ad-hoc production schedule to the control system for controlling the operation of the industrial production or manufacturing facility according to the ad-hoc production schedule.

6. The system according to claim 3, wherein the production scheduling unit is configured to determine at least one of the initial, adapted and further adapted production schedule by further taking into account at least one of a pre-defined capacity utilization, energy efficiency, output quality and throughput time of the industrial production or manufacturing facility.

7. The system according to claim 5, wherein the production scheduling unit is configured to determine at least one of the initial, adapted and further adapted production schedule by further taking into account at least one of a pre-defined capacity utilization, energy efficiency, output quality and throughput time of the industrial production or manufacturing facility.

8. A system for energy supply planning of an energy supplying facility, the system comprising:
an energy supply scheduling unit;
an internal communication interface unit configured to be connected to a control system of the energy supplying facility; and
an external communication interface unit configured to be connected to a production planning system for optimized operation of an industrial production or manufacturing facility, wherein:
the external communication interface unit is configured to receive at least one of an initial production schedule and initial energy demand data from the production planning system;
the energy supply scheduling unit is configured to determine, based on at least one of the initial production schedule and the initial energy demand data, an initial energy supply schedule reflecting an expected time-dependent infeed of energy into at least one energy supply line, the industrial production or manufacturing facility being connected to the at least one energy supply line;
the external communication interface unit is configured to transmit the initial energy supply schedule to the production planning system and to receive, from the production planning system, at least one of an adapted production schedule and adapted energy demand data;
the energy supply scheduling unit is configured to determine an adapted energy supply schedule based on the initial energy supply schedule and at least one of the adapted production schedule and the adapted energy demand data; and
the internal communication interface unit is configured to transmit the adapted energy supply schedule to the control system for controlling the operation of the energy supplying facility according to the adapted energy supply schedule.

9. The system according to claim 8, wherein
the external communication interface is configured to transmit the adapted energy supply schedule to the production planning system and to receive, from the production planning system, at least one of a further adapted production schedule and further adapted energy demand data;
the energy supply scheduling unit is configured to determine a further adapted energy supply schedule based on at least the adapted energy supply schedule and the further adapted production schedule and/or energy demand data; and
the internal communication interface unit is configured to transmit the further adapted energy supply schedule to the control system for controlling the operation of the energy supplying facility according to the further adapted energy supply schedule.

10. The system according to claim 8, wherein the energy supply scheduling unit is configured to determine the initial energy supply schedule by further taking into account a forecast for an availability of energy sources.

11. The system according to claim 8, wherein the control system is configured to control the operation of the energy supplying facility such that at least one of (i) at least one power generation unit is switched on or off and (ii) a specific energy amount is directed towards the at least one energy supply line or away from the at least one energy supply line.

12. The system according to claim 9, wherein the energy supply scheduling unit is configured to derive at least one of initial, adapted and further adapted energy demand data from the initial, adapted and further adapted production schedule, respectively.

13. The system according to claim 9, wherein the energy supply scheduling unit is configured to determine at least one of the initial, adapted and further adapted energy supply schedule by further taking into account at least one of a pre-defined mixture of different energy sources, amount of stored energy, available energy storage capacity, ramp-up and shut-down time of at least one power generation unit.

14. The system according to claim 1, wherein the production schedules and the energy supply schedule or schedules cover a time period which lies in the future a couple of days up to a few months ahead.

15. The system according to claim 8, wherein the production schedules and the energy supply schedule or schedules cover a time period which lies in the future a couple of days up to a few months ahead.

16. The system according to claim 1, wherein the industrial production or manufacturing facility belongs to an energy intensive industry sector.

17. The system according to claim 16, wherein the energy intensive industry sector includes metals processing.

18. The system according to claim 8, wherein the industrial production or manufacturing facility belongs to an energy intensive industry sector.

19. The system according to claim 18, wherein the energy intensive industry sector includes metals processing.

20. The system according to claim 1, wherein the energy supplying facility belongs either to the same enterprise as the industrial production or manufacturing facility or to an independent energy supply company.

21. The system according to claim 8, wherein the energy supplying facility belongs either to the same enterprise as the industrial production or manufacturing facility or to an independent energy supply company.

22. The system according to claim 1, wherein the at least one energy supply line is either a direct line between the energy supplying facility and the industrial production or manufacturing facility or belongs to an energy distribution network.

23. The system according to claim 8, wherein the at least one energy supply line is either a direct line between the energy supplying facility and the industrial production or manufacturing facility or belongs to an energy distribution network.

24. A method for optimized operation of an industrial production or manufacturing facility, wherein an initial, production schedule for the industrial production or manufacturing facility is determined, the method comprising:
establishing a communication connection to a system for energy supply planning;
transmitting at least one of the initial production schedule and initial energy demand data derived from the initial production schedule to the system for energy supply planning;
receiving, from the system for energy supply planning, an initial energy supply schedule containing information which reflect at least one of a time-dependent abundance of energy and a time-dependent shortage of energy available to the industrial production or manufacturing facility via at least one energy supply line;
determining an adapted production schedule based on the initial production schedule and the initial energy supply schedule by re-scheduling at least one production process so that the energy demand of the at least one production process is reduced during a time period when available energy is in short supply an increased during a time period when available energy is not in short supply;
transmitting at least one of the adapted production schedule and adapted energy demand data derived from the adapted production schedule to the system for energy supply planning; and
transmitting the adapted production schedule to the control system for controlling the operation of the industrial production or manufacturing facility according to the adapted production schedule.

25. A method for energy supply planning of an energy supplying facility, the method comprising:
receiving at least one of an initial production schedule and initial energy demand data from a production planning system for optimized operation of an industrial production or manufacturing facility;
determining, based on at least one of the initial production schedule and the initial energy demand data, an initial energy supply schedule reflecting an expected time-dependent infeed of energy into at least one energy supply line, the industrial production or manufacturing facility being connected to the at least one energy supply line;
transmitting the initial energy supply schedule to the production planning system and receiving, from the production planning system, at least one of an adapted production schedule and adapted energy demand data;
determining an adapted energy supply schedule based on the initial energy supply schedule and at least one of the adapted production schedule and the adapted energy demand data; and
transmitting the adapted energy supply schedule to the control system for controlling the operation of the energy supplying facility according to the adapted energy supply schedule.
